(19) United States
(12) Patent Application Publication
(10) Pub. No.: US 2021/0261720 A1
(43) Pub. Date: Aug. 26, 2021

(54) CURING AGENT FOR CURING A RESIN

(71) Applicant: ORINEO BV, Erps-Kwerps (BE)

(72) Inventors: Philippe WILLEMS, Erps-Kwerps (BE); Boke TJEERDSMA, Doorwerth (NL)

(21) Appl. No.: 17/059,898

(22) PCT Filed: May 28, 2019
(86) PCT No.: PCT/EP2019/063721

§ 371 Date: Nov. 30, 2020

(30) Foreign Application Priority Data
May 29, 2018 (BE) 2018/5351

(51) Int. Cl. C08G 59/42; C08L 63/00; C08K 5/11; C08K 5/092

(52) U.S. Cl. CPC C08G 59/4207; C08K 5/092; C08K 5/11; C08L 63/00

(57) ABSTRACT

A curing agent for curing a resin, includes a mixture of an organic acid and an ester.

### FIELD OF THE INVENTION

This invention relates in general to curing agents for curing resins and in particular to curing agents based on organic acids, as well as corresponding methods for curing and for resulting products.

### BACKGROUND OF THE INVENTION

Existing thermocuring agents currently in widespread use are primarily based on petrochemical raw materials and typically have a negative impact on the environment and on public health. For example, the best-known epoxy resin is derived from epichlorohydrin and bisphenol A, for the formation of bisphenol A diglycidyl ether. This bisphenol A diglycidyl ether must then be further cured through the addition of a curing agent (also referred to as a hardener or cross-linker), typically an amine or an anhydride. Alternative hardeners based on phenols and formaldehydes are also known.

Bisphenol A, epichlorohydrin, amines and anhydrides are all known to have significant health risks. These comprise, for example, irritation of the eyes, skin and respiratory passages; allergies affecting the skin and respiratory passages; damage to internal organs such as the liver, kidneys, lungs and brain; impact on the central nervous system, reproduction and hormone regulation; carcinogenic effects; genetic damage; liver and reproductive toxicity, an adverse effect on the hormones; etc.

Epoxy resins are nevertheless frequently used for screed flooring. Epoxy floors have become particularly popular for industrial applications due to their abrasion resistance and impermeability to liquids. In addition, epoxy floors are often used in offices and homes to create a modern or industrial look. A further advantage is that epoxy floors are available in all colours. A disadvantage, however, are the known health risks for the processors of the epoxy resins, the persons who apply these resins in buildings, spaces and on all kinds of substrates and for users of the building. Sufficient ventilation is therefore required during the application and curing, and the regulations regarding working conditions must be complied with. The areas that the epoxy fumes spread to cannot be used at that time. The use of epoxy resins is therefore not without health risks for the processors; approximately one in five of them develops an allergy if the epoxy resin is not yet fully hardened. In some applications, panels are used comprising formaldehyde. This results in health risks for the manufacturers of such panels, health risks for people using buildings where these panels are used, etc.

In addition, some vegetable oil-based epoxy resins are known. The oil is epoxidized for this purpose, by reaction of peroxide, among other things, with the double bonds of the fatty acids. Epoxy resins based on epoxidized vegetable oils partially address the aforementioned problem, since few or no adverse consequences for health and environment are known when using epoxidized oils.

These epoxy resins based on epoxidized vegetable oils must nevertheless also be cured. Three types of curing agents are currently known in particular for that purpose: amines, anhydrides and organic acids. The adverse consequences of using amines and anhydrides have already been cited above, and they remain relevant in this context. Organic acids may be a better alternative but suffer from a lack of reactivity; which needs to be compensated for by using high temperatures (often >130° C.) for the curing process and by combining them with catalysts and/or activators. These catalysts and/or activators are often in turn toxic and contain, for example, carcinogenic organic compounds or heavy metals. Furthermore, using high temperatures is often impractical or impossible for several applications; it is typically not straightforward to cure an epoxy applied on site, for example to form a screed, at high temperatures.

A similar problem also arises for other thermocuring agents, such as polyurethane resins and formaldehyde resins. We can therefore say that to date, there are no known thermocuring agents that can be labelled as totally safe and/or sustainable.

So, there is still a need for curing agents, and combinations of curing agents and resins that at least partially address the aforementioned problems.

### SUMMARY OF THE INVENTION

It is an objective of embodiments of the current invention to provide good curing agents for curing resins. This objective is achieved by curing agents, methods, component kits, products and/or uses according to the current invention.

It is an advantage of embodiments according to the present invention that the curing resins are based on reagents available from biological (e.g. vegetable or animal or microbial) sources.

It is an advantage of embodiments according to the present invention that the curing agents and reagents on which they are based are typically not very or not toxic, as part of which the impact of the curing agents on the health of the processors and users can be minimal. It is an additional advantage of embodiments according to the present invention that the curing agents can also have a minimal impact on the environment.

It is an advantage of at least some embodiments according to the present invention that the curing agents and reagents are based on are typically considered as food-safe.

It is an advantage of embodiments according to the current invention that the curing agents can cause a good and relatively quick curing of a resin at a moderate temperature (for example, at room temperature). It is a further advantage of embodiments according to the current invention that it opens up new areas of application for these resins.

It is an advantage of embodiments of the current invention that the curing agents can be produced and used in an ecological and sustainable manner, for example through the use of renewable raw materials and/or because the production and use are not very or not energy-intensive. It is a further advantage of embodiments of the current invention that the curing agents can be produced and used in an efficient manner, such as in a manner that requires few steps and/or is not very labour-intensive.

It is an advantage of embodiments of the current invention that the curing agents can be obtained in an economically advantageous manner.

It is an advantage of embodiments according to the present invention that the curing agents can have an acid or a neutral pH. It is a further advantage of embodiments according to the present invention that the curing agents are compatible with any reagents or additives (e.g. fillers) in the resin.

It is an advantage of embodiments according to the present invention that the curing agents can be used for curing resins based on biological reagents (e.g. epoxidized vegetable oils). It is a further advantage of embodiments according to the present invention that a cured resin can be obtained entirely from biologically available reagents (e.g. a cured resin obtained from 100% vegetable or animal reagents).

It is an advantage of embodiments according to the present invention that the reagents for making the curing agents and/or the curing agents themselves and/or the resins to be cured and/or the cured resins can be suitable for contact with foodstuffs (e.g. food).

In a first aspect, the present invention relates to a curing agent for curing a resin, containing a mixture of an organic acid or a mixture of organic acids, salts thereof and an ester. In some specific embodiments, the organic acid is a polyvalent organic acid.

In a second aspect, the present invention relates to the method for forming a curing agent as defined in any one of the previous claims, including: (a) mixing a organic acids and an ester, (b) bringing the mixture obtained in a step to a temperature between 10 and 200° C., preferably between 50 and 160° C., more preferably between 120 and 160° C., and (c) optionally, cooling the mixture. In some specific embodiments, the organic acids are a polyvalent organic acid.

In a third aspect, the present invention relates to a kit of components for forming a curing agent as defined in the first aspect or an embodiment thereof, containing an organic acid or a mixture of organic acids and salts thereof and an ester. In some specific embodiments, the organic acids are a polyvalent organic acid.

In a fourth aspect, the present invention relates to a product containing a resin cured with a curing agent as defined in the first aspect or an embodiment thereof.

In a fifth aspect, the present invention relates to a method for curing a resin, including the addition to the resin of a curing agent as defined in the first aspect or an embodiment thereof.

In a sixth aspect, the present invention relates to a kit of components for curing a resin, including (i) a resin; and (iia) a curing agent as defined in the first aspect or an embodiment thereof, or (iib) a kit of components as defined in the third aspect or an embodiment thereof.

In a seventh aspect, the present invention relates to the use of a mixture of an organic acid and an ester for curing a resin. In some specific embodiments, the organic acid is a polyvalent organic acid.

Specific and preferred aspects of the invention are included in the attached independent and dependent claims. Characteristics of the dependent claims may be combined with characteristics of the independent claims and with characteristics of other dependent claims as appropriate and not only as explicitly stated in the claims.

These and other aspects of the invention will become transparent and be clarified with reference to the embodiment(s) described below.

### BRIEF DESCRIPTION OF THE FIGURES

FIG. 1 illustrates a schematic representation of the steps involved in making a curing agent and a cured resin according to the embodiments of the present invention.

The figures are only schematic representations and not limiting. The dimensions of some elements may be exaggerated in some figures and not represented to scale for illustrative purposes.

Reference numbers in the claims should not be interpreted as limiting the scope of protection. In the different figures, the same reference numbers refer to the same or similar elements.

### DETAILED DESCRIPTION OF ILLUSTRATIVE EMBODIMENTS

The present invention will be described in relation to special embodiments and with reference to specific drawings, however, the invention is not limited to this but only limited by the claims. The described drawings are only schematic and not restrictive. For illustrative purposes, the dimensions of some elements may be enlarged in the drawings and not drawn to scale. Sometimes, the dimensions and the relative dimensions do not correspond to the actual practical embodiment of the invention.

In addition, the terms first, second, third, etc. are used in the description and in the claims for discerning similar elements and are not necessary to describe a sequence, not in the time, nor space or ranking or in any other way. It must be understood that the terms used in that manner in suitable circumstances are interchangeable and that the embodiments of the invention set out therein are suitable for working in a different sequence than as set out or reflected therein

Furthermore, the terms uppermost, bottom, above, in front, etc. in the description and in the claims are used for descriptive purposes and not necessarily to describe the relative positions. It must be understood that the terms used—in given circumstances can be mutually exchanged and that the embodiments of the invention set out here are also suitable for work described or reflected according to other orientations than described here.

It must be noted that the term ‘includes’, as used in the claims, must not be interpreted as limited to the resources described therein; this term does not exclude other elements or steps. It can be interpreted as specifying the presence of the mentioned characteristics, values, steps or components referred to, but does not exclude the presence or addition of one or more other characteristics, values, steps, components, or groups thereof. The scope of the expression ‘a device including resources A and B’ must not be limited to devices only made of components A and B. It means that in relation to the current invention, A and B are the only relevant components of the device.

Any reference throughout this specification to ‘one embodiment’ or ‘an embodiment’ means that a specific feature, structure or characteristic described with regard to the embodiment is incorporated into at least one embodiment of the present invention. So, the occurrence of the expressions ‘in one embodiment’ or ‘in an embodiment’ in different places throughout this specification does not necessarily refer to always the same embodiment, but it may do. Furthermore, the specific properties, structures or characteristics can be combined in any appropriate way, which would be obvious to any averagely-skilled specialist based on this notification, in one or more embodiments.

Similarly, it must be appreciated that in the description of embodiments of the invention given by way of example, several properties of the invention are sometime clustered in a single embodiment, figure or description for the purpose of streamlining the public disclosure and for helping to understand one or more different inventive aspects. This method of disclosure must nevertheless not be interpreted as an intention for the invention to require more characteristics than explicitly indicated in each claim. Previously, as reflected by the following claims, inventive aspects are located in less than all characteristics of one single previously disclosed embodiment. So, the claims based on the detailed description are hereby explicitly included in this detailed description, with each independent claim counting as a separated embodiment of this invention.

Furthermore, whereas some embodiments described here include some characteristics that are not included in other embodiments, combinations of characteristics from different embodiments are intended to be situated within the scope of the invention, and forming different embodiments, as will be understood by experts. For example, in the following claims, any of the embodiments described can be used in any combination.

Numerous specific details are put forward in the description given here. It must nevertheless be understood that embodiments of the invention can be executed without these specific details. In other cases, well-known methods, structures and techniques are not shown in detail to keep the description transparent.

The following terms must only be used as support to understand the invention.

As used here, and unless specified otherwise, a ‘mass ratio between component A and component B of X/Y’ means that the ratio between component A and component B is such that for every X mass components of component A, Y mass parts of components B will be present.

As used here, and unless specified otherwise, a ‘catalyst’ means a substance, other than the curing agent, that influences the speed of a chemical reaction without being itself consumed. When the substance, other than the curing agent, is consumed in the reaction, it is referred to as an ‘activator’.

As used here, and unless specified otherwise, ‘room temperature’ indicates a temperature of approximately 20° C.

In a first aspect, the current invention relates to a curing agent for curing a resin, containing a mixture of an organic acid or a mix of organic acids and an ester. In some specific embodiments, the organic acids are polyvalent organic acids.

In embodiments, the resin can be an epoxy resin, an isocyanate resin, an acrylic resin, an alkyd resin, a furan resin, a silicone resin, a polyester resin or another reactive resin, preferably an epoxy resin. In preferred embodiments, the epoxy resin can be an epoxidized vegetable oil, such as but not limited to epoxidized linseed oil or epoxidized soybean oil. Epoxidized vegetable oils are advantageous resins of vegetable origin, which means that they can be obtained in a sustainable manner. Furthermore, few or no adverse health effects or environmental effects are known of these oils. In embodiments, the resin, the organic acids and the ester can be selected so as to ensure that the cured resin is entirely derived from reagents available from biological sources. In some embodiments, the epoxy resin can be a bisphenol A diglycidyl ether resin (i.e. a resin based on bisphenol A and epichlorohydrin). The use of bisphenol A diglycidyl ether resins is advantageously wide-spread and it is therefore well-known how they can be processed in several applications. Furthermore, bisphenol A diglycidyl ether resins can also partially be obtained on the basis of reagents available from biological sources. In embodiments, the mixture can be a solution or suspension of the organic acids in the ester. In embodiments, the mixture (e.g. the solution or suspension) at room temperature can be a liquid or a paste. A liquid (viscous or otherwise) or a paste is advantageously easy to treat and/or process.

In embodiments, the organic acid can include at least two acid functionalities (i.e. the organic acid can be a polyvalent, also a polyprotic acid) or at least one acid functionality and one anhydride functionality. In embodiments, the organic acid can contain a carbon chain of 1 to 100 carbon atoms, preferably of 2 to 50.

In preferred embodiments, the organic acid can be a polyvalent organic acid. In embodiments, the polyvalent organic acid can be selected from the following, without this being an exhaustive list: oxalic acid, malonic acid, maleic acid, fumaric acid, succinic acid, malic acid, tartaric acid, glutaric acid, itaconic acid, adipic acid, citric acid, 2,5-furan dicarboxylic acid, glucaric acid, gluconic acid, pimelic acid, phthalic acid, terephthalic acid, cork acid, azelaic acid, sebacic acid, brassylic acid and dimer acid (e.g. a dimerised fatty acid), and a trimer acid (e.g. a trimerised fatty acid). These polyvalent organic acids can be extracted advantageously from biological (e.g. vegetable or animal) sources or produced through fermentation processes starting from a biological source and can typically be relatively safe for public health and the environment. In embodiments, the dimer or trimer acid can include a carbon chain of at least 10 carbon atoms, such as at least 20 carbon atoms.

In other embodiments, the organic acid can include at least one acid functionality and one anhydride functionality, such as but not limited to trimellitic acid anhydride.

In embodiments, the ester can be selected from, but is not limited to, a lactic acid ester (i.e. a lactate ester such as methyl lactate, ethyl lactate, isopropyl lactate, n-propyl lactate, i-butyl lactate or 2-ethylhexyl lactate), a citric acid ester (i.e. a citrate ester such as triethyl citrate, acetyl triethyl citrate, tributyl citrate, acetyl tributyl citrate or acetyl tris(2-ethylhexyl)citrate), an acetic acid ester (i.e. an acetate ester), a propionic acid ester (i.e. a propionate ester), a benzoic acid ester (i.e. a benzoate ester), an adipic acid ester (i.e. an adipate ester).

These esters can be produced advantageously from biological (e.g. vegetable or animal) sources and can typically be relatively safe for public health and the environment.

In embodiments, the mass ratio between the ester and the organic acid can be between 100/40 and 100/500, e.g. between 100/40 and 100/400.

In the present invention it was surprisingly discovered that a curing agent based on the combination of an organic acid on the one hand and advantageously an ester on the other hand allows a good curing of a resin, and this at a relatively low temperature (e.g. at room temperature). In addition, relatively safe products can be selected for these reagents, which can also be obtained in a sustainable manner.

In embodiments, characteristics of the first aspect and its embodiments can be as set out for another aspect or its embodiments, independently from each other.

In a second aspect, the present invention relates to the method for forming a curing agent as defined in any one of the previous claims, including: (a) mixing one or more organic acids and an ester, (b) heating the mixture obtained in step a to a temperature between 25° and 200° C., preferably between 50° and 160° C., more preferably between 120° and 160° C., and (c) optionally, cooling the mixture. In some specific embodiments, the organic acid is a polyvalent organic acid.

In embodiments, the organic acids and the ester can be at room temperature while step a is performed. In other embodiments, the organic acids and/or the ester may have been preheated (e.g. preheated to the temperature of step b) during the implementation of step a. In embodiments, step a and step b can be performed consecutively or simultaneously.

In embodiments, the organic acid can have a melting point Tₛ and the heating in step b can occur at a temperature between Tₛ−20° C. and Tₛ+20° C., preferably Tₛ−10° C. and Tₛ+10° C., more preferably Tₛ−5° C. and Tₛ+5° C., such as Tₛ. In embodiments, step b can include stirring the mixture.

In embodiments, step c can be: cooling the mixture to room temperature. In embodiments, this cooling can be done actively or passively. In embodiments, the curing agent after cooling can be a liquid, suspension or a paste (see above).

In embodiments, characteristics of the second aspect and its embodiments can be as set out accordingly for another aspect of its embodiments, independently from each other.

In a third aspect, the present invention relates to a kit of components for forming a curing agent as defined in the first aspect or an embodiment thereof, including an organic acid and an ester. In some specific embodiments, the organic acids are polyvalent organic acids.

In embodiments, the kit of components can contain the organic acids and the ester, each in a separate container (e.g. a vial).

In embodiments, characteristics of the third aspect and its embodiments can be as set out accordingly for another aspect or its embodiments, independently from each other.

In a fourth aspect, the present invention relates to a product including a resin cured with a curing agent as defined in the first aspect or an embodiment thereof.

In embodiments, the product can be a floor (e.g. a screed, or floor component, such as a floor tile, tarpaulin, laminate or board), a bottle stopper (e.g. a cork stopper), a binding agent (e.g. for the production of tiles, fibre boards, MDF, laminate sheets, etc.), a matrix material (e.g. for binding granular materials such as cork granulates, rubber granulates, polystyrene granules, etc.), a matrix material for binding fibres such as glass fibres, carbon fibres, basalt fibres, milk fibres or vegetable fibres or a coating or casting product (e.g. on paper or on a furniture element). The expert will understand that this list is not exhaustive and that the resins cured with a curing agent according to the present invention can be used in virtually all the known applications for these resins in the broad specialist field.

In embodiments, the product can be suitable for contact with foodstuffs.

In embodiments, the product can include additional additives, such as fillers (e.g. of vegetable or mineral origin).

In embodiments, characteristics of the fourth aspect and its embodiments can be as set out accordingly for another aspect or its embodiments, independently from each other.

In a fifth aspect, the present invention relates to a method for curing a resin, including the addition to the resin of a curing agent as defined in the first aspect or an embodiment thereof.

In embodiments, the curing can be carried out at a temperature of between 10° to 220° C. In some embodiments, the curing can be carried out at a temperature of between 120° C. and 220° C. In embodiments, the curing can be carried out at a maximum temperature of 150° C., e.g. in a temperature range between 10° C. and 150° C. or for example between 120° C. and 150° C. In some embodiments, the curing can be carried out at a temperature below 100° C., more preferably at a maximum temperature below 60° C., most preferably at room temperature. In embodiments, the method can further include heating up the resin with the curing agent added to it to the curing temperature. The method can advantageously allow for the resin to be cured at a relatively low temperature, and even at room temperature. This method is therefore advantageously sustainable and not very energy-intensive. It furthermore allows the resin to be cured in circumstances when warming up the resin is not practical or even impossible, such as the on-site curing of a screed.

In embodiments, the curing agent can be added to the resin at room temperature. In embodiments, the curing agent may not be preheated. The method advantageously makes it possible that the curing agent does not need to be preheated. As a result, the curing can ideally be carried out in a one-step method (i.e. by combining the curing agent with the resin), optionally supplemented by heating up the resin after it has been added (e.g. if faster curing is preferred).

In embodiments, the curing can be achieved in a period of three minutes to seven days. In embodiments, after curing, wherein an initially suitable hardness is obtained, the resin may spontaneously continue to cure afterwards; the virtually final hardness can be obtained, for example, after a period of 28 days (calculated from the start of the initial curing). The duration of the curing typically depends on the curing temperature used, the mass ratios of the components and any additives, but it may further depend on the desired hardness, for example. At room temperature, the resin can for example cure properly after four to five days, at between 60° and 100° C. in 10 to 20 minutes and at 120° to 160° C. in 3 to 10 minutes.

In embodiments, the cured resin can have a Shore hardness of 40A to 100A, or 10D to 80D. In other embodiments, a softer material may also be obtained, such as a cured resin but with a hardness on the Shore 00 scale.

In embodiments, no catalyst or activator may be used for the curing. The present curing agents typically allow advantageously the obtaining of relatively good and fast curing without the use of catalysts and/or activators. Nevertheless, where required, the addition of a catalyst can still be considered, e.g. for increasing the reaction speed.

In embodiments, the mass ratio between the resin and the curing agent can be 100/10 to 100/150.

In embodiments, characteristics of the fifth aspect and its embodiments can be as set out accordingly for another aspect or its embodiments, independently from each other.

In a sixth aspect, the present invention relates to a kit of components for curing a resin, including (i) a resin; and (iia) a curing agent as defined in the first aspect or an embodiment thereof, or (iib) a kit of components as defined in the third aspect or an embodiment thereof.

In embodiments, the kit of components can include the resin and the curing agent, or the resin, the organic acids and the ester, each in a separate container (e.g. a vial).

In embodiments, characteristics of the sixth aspect and its embodiments can be as set out accordingly for another aspect or its embodiments, independently from each other.

In a seventh aspect, the present invention relates to the use of a mixture of an organic acid and an ester for curing a resin.

In embodiments, characteristics of the seventh aspect and its embodiments can be as set out accordingly for another aspect or its embodiments, independently from each other.

The different aspects can be simple to combine, and the combinations thus also correspond to embodiments according to the present invention.

In some embodiments, aside from the organic acid indicated above, further organic acids can be added, to obtain an additional booster effect for curing of the resin. The further organic acids can be present in a concentration between 0% and 50%, for example between 1% and 20%, e.g. between 5% and 10%. Possible examples of additional organic acids can for example be—but are not limited to—oxalic acid, tartaric acid or malic acid. In other words, in the curing agent, the mixture may be a solution or suspension of more than one organic acid in the ester.

### Example 1: Forming Curing Agents and their Use for Curing Resins

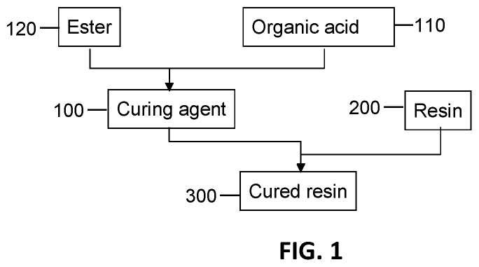

Several curing agents 100 were prepared by mixing an ester 120 with an organic acid 110; as schematically reflected in FIG. 1. If ethyl lactate or butyl lactate was used as an ester. If citric acid, tartaric acid, or a mixture of both were used as organic acid. Specific ratios for four different samples are shown in the table below. For the preparation of each curing agent, the ester and the organic acid (or the mixture of these) were mixed and then heated to 145° C. under continuous stirring, until a clear homogeneous solution was obtained.

Next, several resin systems were prepared by mixing the curing agent 100 with a resin 200; as schematically shown in FIG. 1. For that purpose, 0.375 mass equivalents of the curing agent were allowed to react with 0.625 mass equivalents of epoxidized linseed oil.

These resin systems were then poured into a silicone mould and hardened at 90° C. for 30 minutes to obtain cured resins 300. These were then cooled to room temperature for evaluation. Several tests were carried out on these cured resins to determine their hardness, strength and optical appearance and hence confirm their satisfactory properties.

| | Curing agent | | | | |
|---|---|---|---|---|---|
| | Ester | | Organic acid | | Resin |
| | Ethyl | Butyl | Citric | tartaric | Epoxidized |
| | lactate | lactate | acid | acid | linseed oil |
| | Mass | Mass | Mass | Mass | Mass |
| Sample | fraction | fraction | fraction | fraction | fraction |
| no. | (in %) | (in %) | (in %) | (in %) | (in %) |
| 1 | 12.5 | — | 25 | — | 62.5 |
| 2 | — | 12.5 | 25 | — | 62.5 |
| 3 | 20 | — | — | 17.5 | 62.5 |
| 4 | 12.5 | — | 12.5 | 12.5 | 62.5 |

### Example 2: Curing Time for Different Curing Temperatures

75 g ethyl lactate and 75 g citric acid were mixed and heated to 155° C. for one hour until a light yellow solution was obtained. After cooling to room temperature, the solution became more viscous, but it nevertheless remained liquid. 12 g of this solution was mixed with 20 g of epoxidized oil and 10 g of press-cake and poured into a silicone mould.

Several samples were then cured at different temperatures until they were fully cured. For example, a resin that was fully cured and no longer sticky was obtained after 4 days of curing at room temperature; these and other results are shown in the table below.

| Sample no. | Curing temperature | Curing time | |
|---|---|---|---|
| 5 | room temperature | 4 | days |
| 6 | 70° C. | 15 | minutes |
| 7 | 80° C. | 15 | minutes |
| 8 | 90° C. | 10 | minutes |

### Example 3: Production of Cork Agglomerates

75 g ethyl lactate and 75 g citric acid were mixed and heated to 155° C. for one hour until a light yellow solution was obtained. 7.5 g of this solution was mixed with 7.5 g of epoxidized linseed oil. This mixture was then stirred through 100 g of cork granules and cured under pressure at 140° C. for 30 minutes. A solid cork block was obtained, which furthermore turned out to be waterproof.

### Example 4: Production of Cured Sheets

100 g ethyl lactate, 150 g citric acid and 10 g oxalic acid were mixed and heated to 150° C. until a light yellow solution was obtained. 50 g of this solution was mixed with 100 g epoxidised linseed oil, containing 35 g of dry coffee ground and separated in 2 equal batches. Both batches were poured in a silicone mould. The first batch was cured at 90° C. and hardened to a solid sheet in 10 minutes. The second batch was cured at room temperature and was fully hard in 18 hours.

1.-21. (canceled)

22. A curing agent for curing a resin, containing a mixture of an organic acid and an ester.

23. The curing agent according to claim 22, in which the epoxy resin is an epoxidized vegetable oil.

24. The curing agent according to claim 22, in which the mixture is a solution or suspension of the organic acid in the ester.

25. The curing agent according to claim 22, in which the organic acid contains at least two acid functionalities or at least one acid functionality and one anhydride functionality.

26. The curing agent according to claim 25, in which the organic acid is selected from the group consisting oxalic acid, malonic acid, maleic acid, fumaric acid, succinic acid, malic acid, tartaric acid, glutaric acid, itaconic acid, adipic acid, citric acid, 2.5-furan dicarboxylic acid, glucaric acid, gluconic acid, pimelic acid, phthalic acid, terephthalic acid, cork acid, azelaic acid, sebacic acid, brassylic acid, dimer acids, trimer acids and trimellitic acid anhydride.

27. The curing agent according to claim 22, in which the ester is selected from the group consisting a lactic acid ester, a citric acid ester, an acetic acid ester, a propionic acid ester, a benzoic acid ester and an adipic acid ester.

28. The curing agent according to claim 22, with a mass ratio between the ester and the organic acid of 100/40 to 100/500.

29. The curing agent according to claim 22, in which the curing agent is food-safe.

30. A method for forming a curing agent as defined in claim 22, including:
(a) mixing an organic acid and an ester,
(b) bringing the mixture obtained in step a to a temperature between 10 and 200° C., and
(c) optionally, cooling the mixture.

31. A kit of components for forming a curing agent as defined in claim 22, including:
an organic acid and
an ester.

32. A product comprising a resin cured with a curing agent as defined in claim 22.

33. A method for curing a resin, including the addition to the resin of a curing agent as defined in claim 22.

34. The method according to claim 33, wherein the curing is achieved at a maximum temperature of 150° C.

35. The method according to claim 33, wherein no catalyst or activator is used for the curing.

36. The method according to claim 33, with a mass ratio between the resin and the curing agent of 100/10 to 100/150.

37. A kit of components for curing a resin, including:
(i) a resin; and
(iia) a curing agent as defined in claim 22.

38. The kit of components for curing a resin, including:
(i) a resin; and
(iib) a kit of components as defined in claim 31.

39. A use of a mixture of an organic acid and an ester for curing a resin.

40. A use of a mixture according to claim 39, for curing a resin at room temperature.

41. A use of a mixture according to claim 39, in which the cured product is food safe.
